(19) United States
(12) Patent Application Publication
(10) Pub. No.: US 2016/0260339 A1
(43) Pub. Date: Sep. 8, 2016

(54) SYSTEM FOR TAKING NOTES

(71) Applicant: Apollo Education Group, Inc., Phoenix, AZ (US)

(72) Inventors: Sudhakar Subashchandrabose, San Jose, CA (US); Anil Maipady, San Jose, CA (US); Raghavendra Reddy Mooram, Sunnyvale, CA (US); Narender Vattikonda, San Jose, CA (US); Sajithkumar Kizhakkiniyil, Pleasanton, CA (US); Shridhar Navanageri, Cupertino, CA (US)

(21) Appl. No.: 14/635,242

(22) Filed: Mar. 2, 2015

(51) Int. Cl. G09B 5/02; G09B 5/04; G06F 17/30; G09B 5/06

(52) U.S. Cl. CPC G09B 5/02; G09B 5/06; G09B 5/04; G06F 17/30864

(57) ABSTRACT

A method of operating an online teaching system provides an activity tool that enables participation in an activity related to a learning object. The method provides a note tool for taking notes. The method determines that notes taken by users using the note tool were taken in conjunction with the users participating in an activity using the activity tool. Metadata is generated for notes based on any of: semantic analysis of content of each note, content of the learning object, performance information that indicates how the user that created the note performed on tasks, performance information that indicates how users that read the note performed on tasks, or professional performance information of the user that created the note. The method stores data that associates the notes with the metadata generated for each note. The method performs further action on notes based on the metadata generated for each note.

### FIELD OF THE INVENTION

The present invention relates to academic note taking automation including entry, automatic analysis of notes, and automatic assessment of the effectiveness of learning materials.

### BACKGROUND

Students create personal notes during study and class to facilitate later review of subject matter when preparing to take a test or complete an assignment. The tools used by the students to take notes are referred to herein as “note entry tools”. Conventionally, note entry tools were simply a pad of paper and a pencil. More recently, student use “paperless” note entry tools, such as word processors of electronic “notepads”. Typically, only the student that makes a set of notes uses the set of notes. However, in some cases, students can share their notes by given physical or electronic copies of their notes to other students. If it were easier to share useful notes with others, students may be able to learn and retain information better.

### BRIEF DESCRIPTION OF THE DRAWINGS

In the drawings:

FIG. 1 is a block diagram that depicts a note taking system.

FIG. 2 depicts a flowchart of the operation of a note taking system.

FIG. 3 is a block diagram that depicts a note taking system.

FIG. 4 depicts an example screen displayed by an example tablet of a note taking system.

FIG. 5 is a block diagram that depicts a note taking system.

FIG. 6 depicts an example screen displayed by an example tablet of a note taking system.

FIG. 7 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A note taking system is described hereafter which joins presentation of course materials with capture of student notes. The note taking system automatically analyzes student notes to generate metadata. The note taking system stores the notes and their metadata. The note taking system analyzes the notes, their content, and their metadata to:

infer new metadata,

isolate interesting locations within learning objects,

detect and send alerts about learning objects that need revising, and

automatically generate and propose rough drafts of revisions to learning objects.

In one embodiment, an online teaching system provides users, such as students, an activity tool that enables participation in an activity related to a learning object. “Learning object”, as used herein, refers to anything designed to provide students a learning experience. For example, a learning object may include a document, an audio recording, an image, a video, etc. designed to teach something.

In addition to the activity tool, users are also provided with a note tool for taking notes. The activity tool and the note taking tool are integrated to the extent that a computerized system is able to automatically determine that notes taken by the users using the note tool were taken in conjunction with the users participating in an activity using the activity tool. That is, the computerized system is able to determine and record the fact that note X taken by user Y relates to the learning activity associated with learning object Z.

According to one embodiment, not only does the computerized system keep track of the relationships between notes and learning objects, but the system also automatically generates metadata for each of the notes based, at least in part, on at least one of: a semantic analysis of content of the note, content of the learning object, note creator performance information that indicates how the user that created the note performed on one or more tasks, note reader performance information that indicates how users that read the note performed on one or more tasks, or professional performance information of the user that created the note.

The computerized system stores data that associates each of the notes with the metadata generated for the note is able to perform further actions on notes based, at least in part, on the metadata generated for each note.

According to an embodiment, the computerized system analyzes the notes, their content, and their metadata to infer new metadata, detect and alert learning objects that need revising, and propose rough drafts of revisions to learning objects.

These embodiments may fulfil particular uses that prior techniques do not address, such as:
determining the effectiveness of a learning resource based on the content of a note made while consuming the resource and automatically isolating areas for improvement and proposing revisions,
mapping notes to a concept map or a category,
taking notes on any type of target learning object delivered through internet,
associating notes to any type of target learning object, and
exchanging notes in bulk with external systems.

### Structural Overview of a Note Taking System

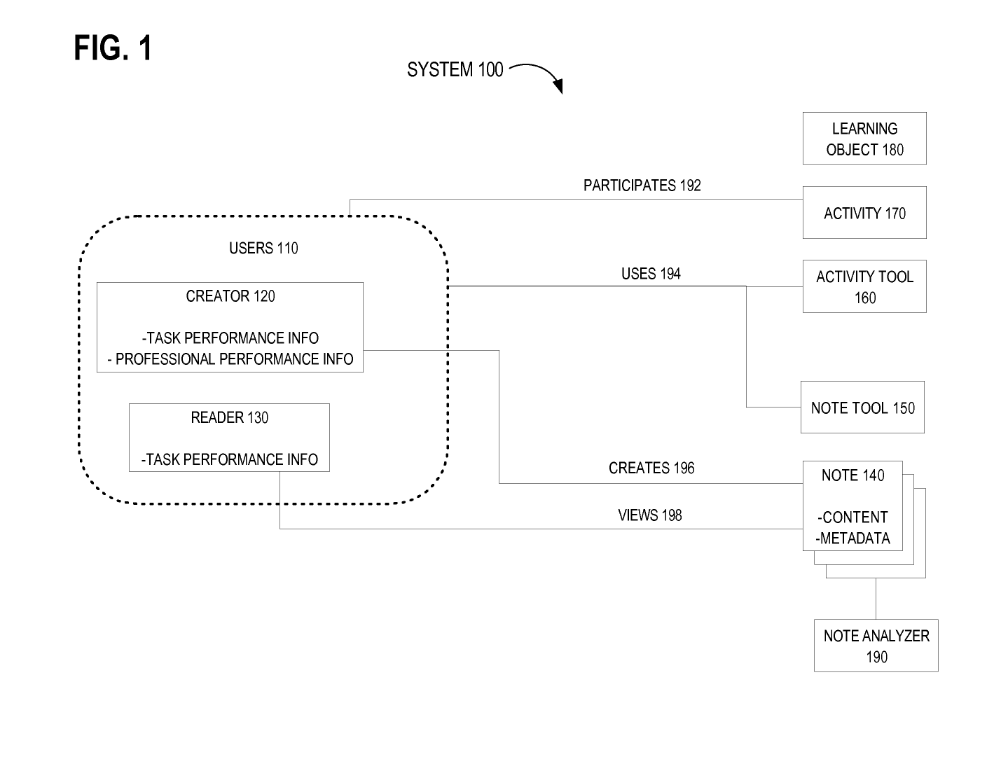

Techniques are described hereafter for an improved system for taking notes. FIG. 1 is a block diagram that depicts note taking system 100 for improved note taking, according to embodiments. Note taking system 100 generally represents one or more computing devices, each of which may have any number of processors, volatile memory, and access to persistent storage that may be local or shared. Note taking system 100 comprises activity tool 160, note tool 150, and note analyzer 190.

Users 110 represents many users of note taking system 100, such as students in an academic course, equipped with computerized note taking devices such as personal computers (PCs), smartphones, or other networked computers that support text entry and web browsing. Uses 194 generally represents the usage of tools 150 and 160 by users 110. In one embodiment, tools 150 and 160 are software applications that execute, at least in part, on the computers of users 110. Tools 150 and 160 may be web applications that are hosted on remote servers and presented to users 110 over a communication network, such as a local area network or the global Internet, and requiring middleware such as a web browser. Alternatively, tools 150 and 160 may be dedicated applications installed on the computers of users 110 or tiered applications that require client installation and a remote server. Each of users 110 may simultaneously use one or both of tools 150 and 160.

### The Activity Tool

Activity tool 160 enables participation in activities related to learning objects. In FIG. 1, the label “participates 192” generally represents the notion that users 110 are participating in activity 170. Such participation is enabled by activity tool 160. For the purpose of explanation, it shall be assumed that activity 170 is an activity related learning object 180. For example, activity 170 may be a lesson, lecture, tutorial, or other learning activity that involves users 110 either simultaneously or independently.

### The Learning Object and Activity Tool

Learning object 180 may be, for example, online learning material, such as a web page, computer simulation, video, audio, slide show, or electronic book. Learning object 180 has content including subject matter relevant to concepts taught in activity 170. Activity 170 may have multiple learning objects. Learning object 180 may be shared by multiple activities. Activity tool 160 may simultaneously administer multiple activities to different users. Activity tool 160 may provide access to learning object 180 over the global Internet.

### The Note Tool

Note tool 150 enables taking, viewing, and revising notes, such as note 140, that record personalized details that supplement an activity or learning object and assist retention of taught concepts. Notes are produced and consumed by users 110. Creates 196 depicts creation of note 140 by creator 120, which is one of users 110. Creator 120 uses note tool 150 to enter text or other content that regards an activity or learning object. Note 140 may be shared with other users 110. Views 198 depicts reading of note 140 by reader 130, which is one of users 110. Users 120 and 130 may be the same user or different users. Note 140 may have multiple readers. Creator 120 may create multiple notes. A note need not be associated with a learning object. For example, an agenda note may be generally associated with a course or an activity.

Note tool 150 may enable creation of notes having rich content. Note tool 150 may include a typesetting word processor. Note tool 150 may include an audio or video recorder. Note tool 150 may include a mathematical formula editor capable of rendering exotic mathematical symbols, scalable parentheses, and nested radicals and fractions. Note tool 150 may include an editor having awareness of a programming language, such as included in an integrated development environment (IDE). Note tool 150 may provide code completion, syntax highlighting, error checking, tool tips, reference documentation, and perhaps an execution harness such as a debugger. Either of tools 150 or 160 may include a simulator dedicated to subject matter, such as a chemical reaction simulator, a biological population simulator, a math equation solver, or a mathematical calculator.

### Storing and Processing Notes

Although not shown, note taking system 100 has a central repository that persists notes. Although note tool 150 may be capable of offline operation without a network connection, note tool 150 is configured to upload notes to the central repository when a network connection is available. If connected to a network, note tool 150 may upload notes immediately after note creation or as note text is being entered, such as if note tool 150 has a user interface that is a thin client, such as a web browser.

Note analyzer 190 is configured to process notes after creation. Depending on the implementation, this processing may be performed by either of tools 150 and 160, by a central computer not shown, or by some combination of these. Note processing has a variety of inputs including details of note content, note creator, note readers, and the activity and learning objects involved during note creation. Because a note may be repeatedly read after creation, and note processing may be partly based on those readings, note processing may be an ongoing or repeated process for a note.

According to one embodiment, note processing by note analyzer 190 includes generating and storing metadata in association with the notes. Such metadata may take many forms. Various forms of metadata, such as related learning object metadata, performance metadata, location data, categorization metadata, and semantic analysis metadata, are described in greater detail hereafter. However, the techniques described herein are not limited to any particular type of note metadata.

After generating metadata for notes, note analyzer 190 stores the metadata. In one embodiment, note analyzer 190 stores the metadata in the same repository as the notes. Subsequently, note taking system 100 may retrieve a note or metadata associated with a note. Note taking system 100 is configured for further action with stored notes and their associated metadata.

### Related Learning Object Metadata

According to one embodiment, the metadata generated when processing a note includes metadata that indicates the learning object(s) that correspond to the note. The note taking system 100 may be configured to automatically determine which learning object(s) correspond to a note in any one of a variety of ways. For example, note tool 150 may require a user select an activity or learning object before creating a note. As another example, note analyzer 190 may infer an interrelationship between note 140 and an activity or learning object based on concurrent use of activity tool 160 that regards activity 170 and learning object 180. Note creation time may be sufficient for note analyzer 190 to infer an interrelationship between a note and an activity or learning object based on an online learning schedule.

### Performance Metadata

Metadata generation may be ongoing or repeated for a note. After note creation, note taking system 100 may obtain a performance assessment of users 110 at subsequent related academic tasks, such as a test, a quiz, or an assignment. Metadata generation for note 140 may be based on performance information that indicates how creator 120 performed on some related tasks. For example activity tool 160, note tool 150, or another software tool of note taking system 100 may administer to creator 120 an online quiz regarding content of learning object 180 for which creator 120 created note 140. Note taking system 100 may record a performance score based on a performance of the online quiz by creator 120. Based on the performance score, note analyzer 190 may generate metadata for note 140, such as metadata indicating a level of retention of the subject matter of learning object 180.

Metadata generation for note 140 may be based on performance information that indicates how readers of note 140, such as reader 130, performed on some related tasks. For example, note tool 150 may measure an amount of time reader 130 spent viewing note 140 that regards learning object 180. Note analyzer 190 may generate metadata that correlates quiz performance by reader 130 with time spent viewing note 140.

With sufficient passage of time, metadata generated for note 140 may be based on professional performance information that indicates how creator 120 subsequently exploited concepts taught with activity 170 and learning object 180, such as in commerce. For example a school may track initial careers and salaries of users 110, and add performance metadata to the notes that were created by users 110 based on those careers and salaries. Note analyzer 190 may generate metadata for note 140 that indicates whether creator 120 that created note 140 has passed a professional licensing exam related to the subject matter of learning object 180 associated with note 140.

### Location Metadata

According to one embodiment, note analyzer 190 generates some metadata concurrently with the creation of a note. For example, note analyzer 190 may generate metadata for a note that directly relates the note with the learning object that it regards. Note analyzer 190 may generate metadata that indicates a location within the learning object. For example, learning object 180 may be an electronic book, and note analyzer 190 may generate metadata that indicates that note 140 is associated with a fifteenth page of learning object 180.

For example activity tool 160, note tool 150, or another software tool of note taking system 100 may function as an electronic book viewer. Note tool 150 may interoperate with the electronic book viewer to generate metadata that indicates which page of the electronic book is currently viewed. Likewise, the interoperation of the electronic book viewer and note tool 150 may enable navigation from note tool 150 to a particular page of the electronic book based on location metadata associated with a note currently loaded in note tool 150.

As another example, learning object 180 may be a video lecture, and note analyzer 190 may generate metadata that indicates that note 140 is associated with a fifteenth minute of learning object 180. Activity tool 160, note tool 150, or another software tool of note taking system 100 may function as a video player. Note tool 150 may interoperate with the video player to generate metadata that indicates which minute of the video lecture is currently viewed. Likewise, the interoperation of the video player and note tool 150 may enable navigation from note tool 150 to a particular minute of the video lecture based on location metadata associated with a note currently loaded in note tool 150.

Reader 130 may use activity tool 160 during activity 170 to view learning object 180, which may be an electronic book. Activity tool 160 may currently show the fifteenth page of learning object 180. In response to showing the fifteenth page, the activity tool 160 may:
determine, based on the location metadata associated with the notes, which notes relate to the fifteenth page; and
generate and display a list of those notes associated with the fifteenth page.

According to one embodiment, activity tool 160 uses the location metadata associated with the notes to provide interactive navigation to notes. For example, if a user selects a particular note from the list of notes associated with the fifteenth page, activity tool 160 launches note tool 150 to open and display the selected note.

### Semantic Analysis Metadata

According to one embodiment, as part of note processing, note analyzer 190 performs semantic analysis of the content of stored notes, such as text analysis or metadata analysis. Semantic analysis by note analyzer 190 may detect concepts referenced in notes. Semantic analysis may involve text analytics, processing of embedded hyperlinks, processing of existing metadata of a learning object associated with a note, or analysis of other details associated with the note.

Note analyzer 190 may perform text analysis that detects a presence of particular words or measures vocabulary overlap between notes or between a note and a learning object. Note analyzer 190 may perform text analysis based on a word cloud or a histogram of word usage. Note analyzer 190 may perform text analysis that includes conceptual analysis to measure conceptual overlap between a note and a learning object.

Note analyzer 190 generates metadata based on the semantic analysis. For example, generated metadata may enumerate relevant concepts addressed by a note or indicate a level of depth or superficiality of a note.

### Categorization Metadata

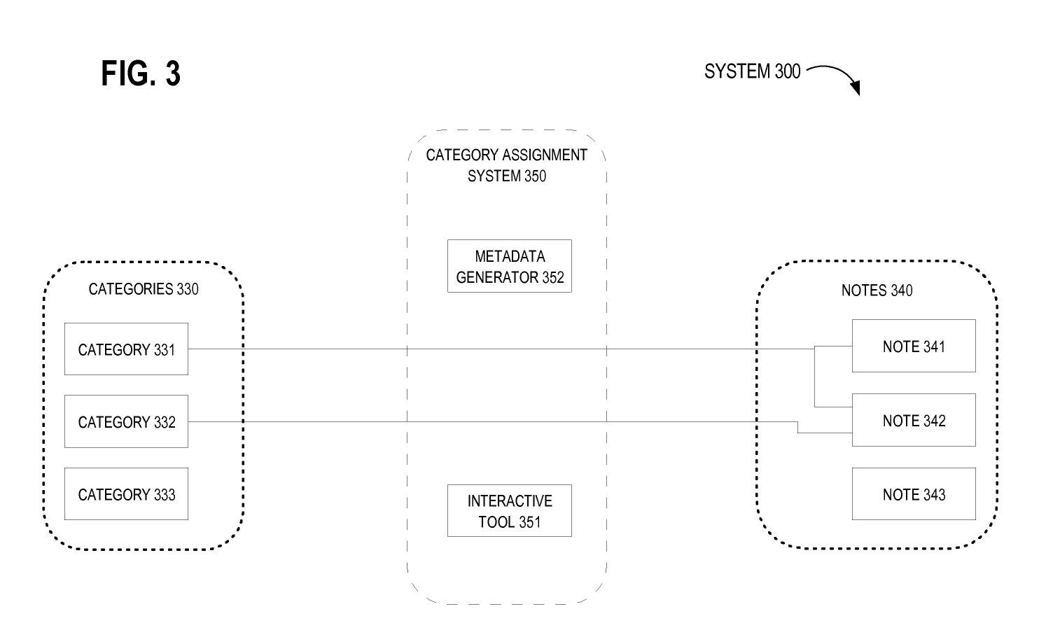

FIG. 3 illustrates a note categorization system 300, in an example embodiment. Note categorization system 300 may be an implementation of note taking system 100, although note taking system 100 may have other implementations. Although some components are not shown, such as users 110, note categorization system 300 includes all of the components of note taking system 100. Note categorization system 300 also includes notes 340, category assignment system 350, and categories 330. Notes 340 includes notes 341-343. Categories 330 includes categories 331-333.

According to one embodiment, each of categories 330 is a reusable descriptor that classifies or clarifies an aspect of a note. For example, category 331 may generally rate the quality of a note as some gradation such as good, poor, important, or irrelevant. Category 331 may clarify a context or purpose of a note such as corrections to or summary of a learning object. Category 331 may be a reminder or suggestion such as a need to rephrase a learning object. Categories function as reusable tags that may be associated with notes. Multiple notes may share a category. For example, notes 341-342 are tagged with category 331. Multiple categories may tag a note. For example, note 342 is tagged with categories 331-332. A category may be unused, such as category 333. A note may be untagged, such as note 343.

Tagging a note with a category is accomplished by category assignment system 350, which includes metadata generator 352 and interactive tool 351. Interactive tool 351 may be an implementation of note tool 150, although note tool 150 may have other implementations. Interactive tool 351 allows users 110 assign a category to a note. Interactive tool 351 may offer pre-defined categories, may accept new categories created on demand, and may offer categories that were previously created on demand.

Metadata generator 352 may be an implementation of note analyzer 190, although note analyzer 190 may have other implementations. Note categorization system 300 may use metadata generator 352 to automatically assign categories to notes based on analysis performed during metadata generation. Categories and their assignments are themselves metadata that note categorization system 300 may store and use during subsequent processing of notes. For example, note categorization system 300 may automatically perform steps such as identifying notes that bear a specific category, such as rephrase, selecting a learning object associated with the most notes tagged with the rephrase category, and presenting to an author of the learning object an indication that the learning object needs rephrasing based on feedback from users 110.

### Identifying and Reducing Redundancy

As note analyzer 190 performs semantic analysis on notes, note analyzer 190 may recognize redundancy between notes that are associated with a same activity or learning object. Note analyzer 190 may determine from this recognized redundancy that content of the redundant notes can be consolidated. Note analyzer 190 may automatically synthesize a generated note that consolidates the content of the redundant notes. Note analyzer 190 may generate a consolidated note based on the metadata of the redundant notes. Note analyzer 190 may store the generated note as a replacement of the redundant notes.

### Exchanging Notes

According to one embodiment, tools 150 and 160, or other components of note taking system 100, support exchange of stored notes. For example, a user may cause activity tool 160 to export selected or all notes associated with learning object 180. Note taking system 100 may export notes in common interchange formats such as a word processing document, a spreadsheet, or extensible markup language (XML). Note taking system 100 may enable a user to import notes in such formats, individually or in bulk. Importing and exporting may facilitate interoperation with third party note taking applications and other isolated applications.

### Learning Object Metadata

According to one embodiment, note taking system 100 may have access to metadata associated with the learning objects used to teach users 110. The metadata associated with a learning object may include metadata that indicates the subject matter concepts that are covered by the learning object. According to one embodiment, semantic analysis by note taking system 100 makes use of the learning object metadata to determine an amount of semantic overlap between a note and a learning object.

### Functional Overview of a Note Taking System

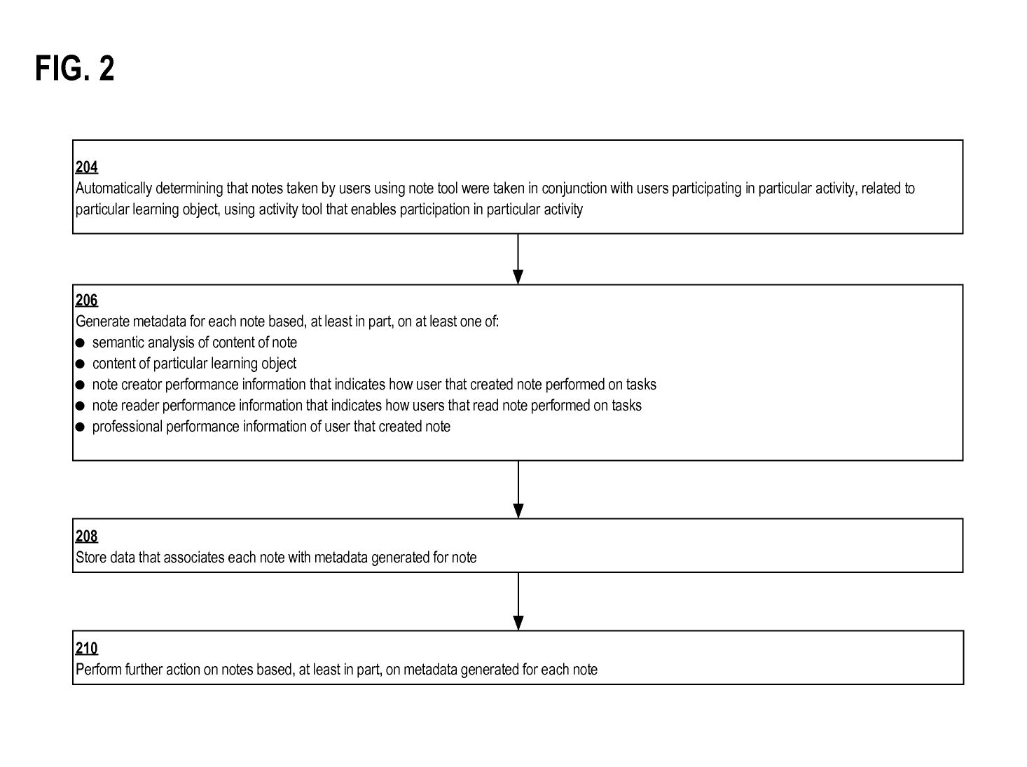

FIG. 2 illustrates a process for taking notes, in an example embodiment. For purposes of illustrating a clear example, FIG. 2 may be described with reference to FIG. 1, but using the particular arrangements illustrated in FIG. 1 is not required in other embodiments.

Activity tool 160 and note tool 150 are provided to users. As mentioned above, activity tool 160 enables participation in activity 170 related to learning object 180. For the purpose of explanation, it shall be assumed that example activity 170 is a geometry lesson, and that learning object 180 is a video of a lecture that teaches the geometry lesson. Under these circumstances, activity tool 160 would typically be an application that plays videos, such as a web browser. As mentioned above, note taking system 100 also includes note tool 150, which users 110 use to create notes, such as note 140, that regard activity 170 and learning object 180. Association of notes with activities and learning objects facilitates subsequent processing of the notes.

In step 204, note taking system 100 automatically determines that notes, such as note 140, taken by users 110 using note tool 150 were taken in conjunction with users 110 participating in activity 170 using activity tool 160 (e.g. while watching the video of the geometry lecture).

In step 206 metadata is generated for each note. Each note has many associated information sources that note analyzer 190 may use to generate metadata for the note. Note analyzer 190 may generate metadata based on semantic analysis of the content of a note.

In step 208 data is stored that associates each note with metadata generated for the note. Note taking system 100 may have a relational database system that persists notes, metadata, and associations between them. Data storage may instead directly use a file system. Indexing for subsequent searching may enable additional features. Note taking system 100 may store and process notes and metadata for years, including repeated uses of the same activities and learning objects.

In step 210, note taking system 100 performs a further action on stored notes based on metadata generated for each note. Note taking system 100 may make the notes available for sharing amongst users 110, a teacher, or an author of learning materials, such as learning object 180. Note taking system 100 may score, grade, or otherwise assess the quality of the notes, perhaps for consideration by the teacher during student evaluation. Note analyzer 190 may process the notes to identify learning objects that may generally need improvement or to identify a specific weakness of a learning object.

### Browsing Notes

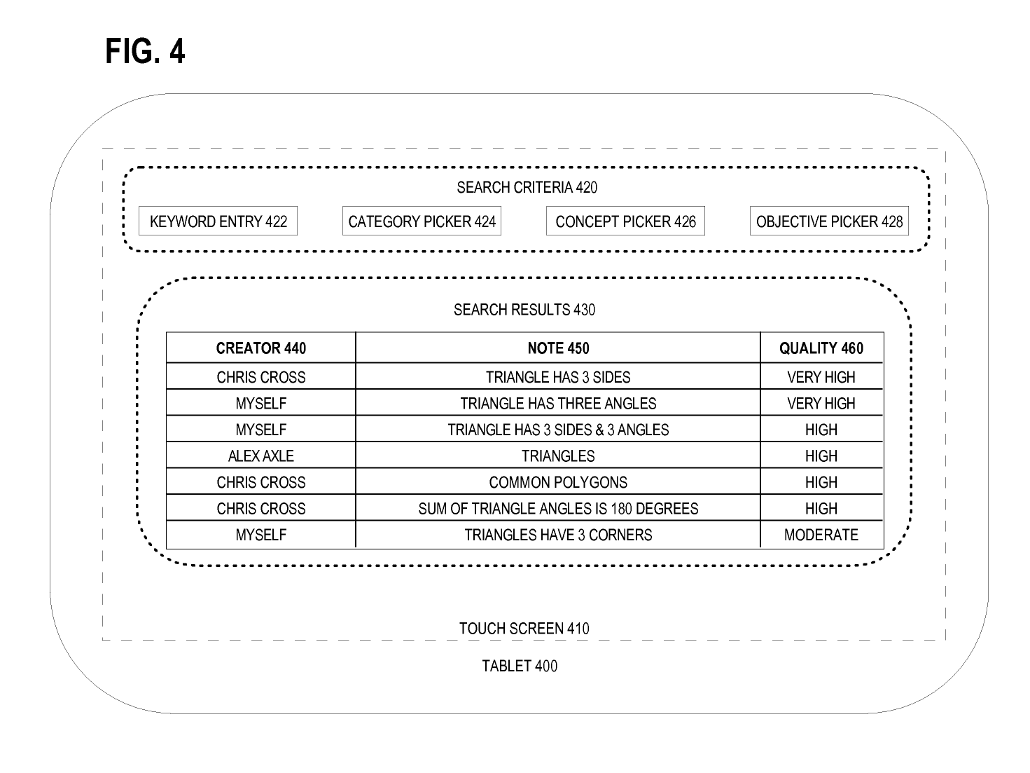

FIG. 4 illustrates tablet 400 for retrieving notes according to criteria, in an example embodiment. Tablet 400 may be part of note taking system 100, although note taking system 100 does not require tablet 400. Tablet 400 may be a tablet, a smartphone, a PC, or any other networked computer configured to transmit search criteria and receive search results. Tablet 400 has touch screen 410, which may be a touch display with an integrated touch sensor or a display monitor used in conjunction with a pointing device such as a mouse. Each of users 110 may have a tablet 400.

Touch screen 410 shows search criteria 420, which is a screen region where users 110 may enter keywords, categories, activities, learning objects, or other meaningful criteria that correlate with centrally stored notes. Search criteria 420 may include various user interface widgets to facilitate interactive entry or selection of criteria such as a text entry field, category multi-selection pickers, and menus that inventory learning objects and activities. For example, search criteria 420 includes widgets 422, 424, 426, and 428.

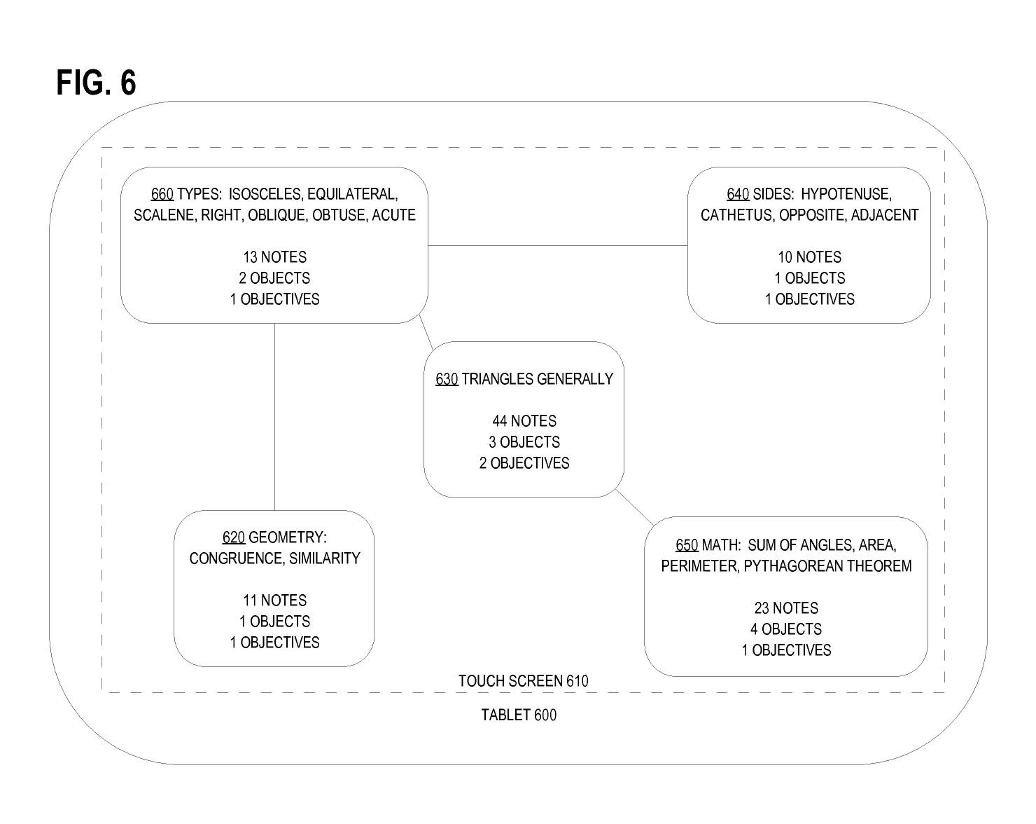

Keyword entry 422 captures search keywords entered as text. Pickers 424, 426, and 428 may be combo boxes or other item selection widgets. Category picker 424 limits searching to notes tagged with a particular category metadata. Concept picker 426 limits searching to notes associated with a particular academic concept, as determined by metadata generated by semantic analysis. Objective picker 428 limits searching to notes associated with a particular learning objective. Learning objectives are explained below in the discussion of FIG. 6.

After criteria are entered, tablet 400 transmits the criteria to a central server that is connected to a repository of stored notes and metadata, such as categories and note authorship. The central server may be a database server that processes the criteria as a query to find notes that match the criteria. The central server may be an application server, such as a web server, that summarizes the found notes, formats the summaries for serialization, and transmits the serialization back to tablet 400. For example, touch screen 410 may be showing a web browser to which the web server may respond by sending formatted HTML that encodes summaries of the found notes.

Upon receiving serialized summaries, tablet 400 may render them as search results 430, which in this example is tabular such as an HTML table. Each table row in search results 430 may correspond to a note that matches the criteria. Search results 430 may be paginated to accommodate many matching notes. Search results 430 may show note column 450 that has a title of each matching note. A creator of a note may have assigned the note a title. Note taking system 100 may have automatically assigned the note a title, perhaps harvested from text of the note, such as a first line of text in the note. Note column 450 facilitates user recognition of individual notes and may provide insight as to specifics of each note.

Search results 430 may show creator column 440 that indicates authorship of each note. An implementation of note taking system 100 may capture a privacy setting for each note that indicates who may view the note. For example note tool 150 may have an interactive checkbox that a creator of a note may set to enable sharing the note with other students. Notes by multiple creators may appear in search results 430 so long as privacy settings have enabled sharing of those notes. Notes with privacy settings that disable sharing will not appear in search results 430. Regardless of privacy settings, search results 430 may always list notes created by a user currently using tablet 400.

Search results 430 may show quality column 460 that indicates a relative quality of each note. Rows of search results 430 may be sorted by quality to emphasize the best notes that match the search criteria. Quality may be objectively determined by automatic comparison of alignment between a note and its associated learning object based on semantic analysis, category metadata, concept metadata, or word usage. Quality may be subjectively determined based on popularity of a note. Popularity may be a ranking derived from express feedback of users who viewed and assessed the helpfulness of a note, perhaps by tallying presses of thumb up and down buttons. Popularity may be automatically inferred, perhaps by tallying an amount of views of a note or recency of a last view of the note. Quality may be an integration of objective and subjective factors. Quality may be stored as metadata for purposes other than search results sorting, such as any subsequent action that involves note metadata.

### Curation of Learning Objects

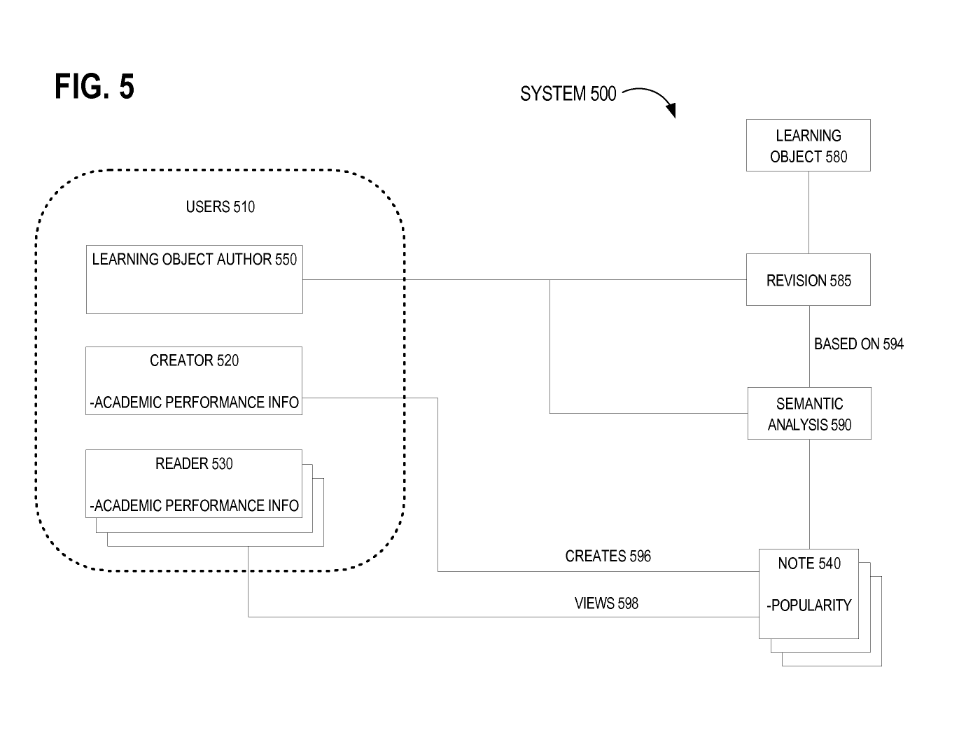

FIG. 5 illustrates curation system 500 for curating learning objects based on notes, note content, and note metadata, in an example embodiment. Curation system 500 may be an implementation of note taking system 100, although note taking system 100 may have other implementations. Although some components are not shown, such as note tool 150, curation system 500 includes all of the components of note taking system 100. Curation system 500 also includes note 540, learning object 580, and users 510.

Curation system 500 is configured to facilitate authors revising their learning objects based on notes, note content, and note metadata. After sufficient notes are accumulated, curation system 500 may process stored notes and metadata to identify learning objects that need refinement. If shared note 540 is widely appreciated as helpful at further explaining concepts of learning object 580, then note 540 is likely to be popular. Curation system 500 may select and present note 540, having a high popularity score, to an author of learning object 580. Curation system 500 may automatically indicate to the author that learning object 580 associated with popular note 540 needs revising. Based on the contents of popular note 540, curation system 500 may generate revision 585 of learning object 580. The author of learning object 580 may use generated revision 585 as a rough draft for manually crafting a more suitable revision.

Curation system 500 may use location metadata, in conjunction with other metadata or analysis, to automatically identify a location within learning object 580 that may need improvement. For example location metadata and other metadata may be used to detect that a particular page of an electronic book causes confusion for users 110.

As another example, learning object 580 may be a 1-hour audio lecture. Metadata of note 540 may associate note 540 with the fifteenth minute of the audio lecture. The content of note 540 may be a partial transcript of the fifteenth minute of the lecture. Popularity of note 540 may be due to use of the note by students as a supplement to the fifteenth minute which is almost inaudible. Based on the popularity of note 540, curation system 500 may report learning object 580, together with note 540, to an author with an automatic recommendation that the fifteenth minute needs revising.

As another example, learning object 580 may be an electronic book, and note 540 may be a note that explains subject matter presented in the book. If note 540 is shared, curation system 500 may detect that note 540 was viewed by many students. Curation system 500 may select note 540 based on its wide viewership, which curation system 500 may take as an indication that learning object 580 may need revising.

Metadata of note 540 may indicate that note 540 regards the fifteenth page of the book. Further metadata, either manually entered or automatically inferred, may indicate that the wording of the fifteenth page is confusing and that note 540 contains a clearer explanation of the subject matter. For example, text analysis by curation system 500 of learning object 580 and note 540 may indicate that learning object 580 and note 540 discuss the same subject matter, that learning object 580 is poorly worded, and that note 540 is not poorly worded. Curation system may use the content of note 540 and semantic analysis 590 of note 540 as a basis for automatically generating revision 585 of learning object 580, shown as based on 594.

Learning object author 550 may adopt and modify revision 585, ratify revision 585 as is, or use semantic analysis 590 to manually craft a new revision of learning object 580. For example, if note 540 has a hyperlink to an external resource, learning object author 550 may review the external resource to determine which concepts or presentation techniques of the external resource would be beneficial to incorporate into a revision of learning object 580.

As another example, learning object 580 may be a slide show, and note 540 may be one of many notes having metadata that indicates the fifteenth slide. Curation system 500 may detect that the fifteenth slide is indicated by metadata of many notes. Curation system 500 may select the fifteenth slide of learning object 580 based on its accumulation of many notes, which curation system 500 may take as an indication that the fifteenth slide may need revising. Curation system 500 may report this automatically determined need to revise the fifteenth slide to the author of learning object 580.

As another example, note 540 may have been created by creator 520 of users 510, shown as creates 596. Creator 520 may have discovered an external online resource, such as a web page, that supplements learning object 580. Creator 520 may embed within note 540 a hyperlink to the external online resource. If creator 520 adjusts the privacy settings of note 540 to allow sharing, then multiple readers of users 510, such as reader 530, may view note 540, shown as views 598. Readers, such as reader 530, may use the embedded hyperlink to view the external online resource. If the embedded hyperlink is used from within note tool 150, then curation system 500 may record how much time readers spend viewing the external online resource.

Curation system 500 may process the aggregate time spent viewing the external online resource as an indication of how valuable is the external online resource as a supplement of learning object 580. Curation system 500 may recommend revising learning object 580 based on the aggregate time spent viewing the external online resource and may recommend to the author of learning object 580 that the external online resource has valuable content that may be incorporated into revision 585 of learning object 580.

Curation system 500 may track academic performance information of users 510. High academic performance of a user may indicate exposure to high quality notes. Curation system 500 may identify notes, such as note 540, associated with particular users that have high academic performance. Notes created by a creator that performed well may be valuable. Curation system 500 may select note 540 as valuable because that note was created by creator 520 that performed well. Curation system 500 may recommend that learning object 580 be revised or generate revision 585 based on note 540 because of the performance of creator 520.

Likewise, notes viewed by readers that performed well may be valuable. Curation system 500 may select note 540 as valuable because that note was viewed by readers, such as reader 530, that performed well. Curation system 500 may recommend that learning object 580 be revised or generate revision 585 based on note 540 because of the performance of readers such as reader 530.

### Concept Map

FIG. 6 illustrates tablet 600 for navigating a concept map, in an example embodiment. Tablet 600 may be part of note taking system 100, although note taking system 100 does not require tablet 600. Tablet 600 may be an implementation of tablet 400, although tablet 400 may have other embodiments. Tablet 600 may be a tablet, a smartphone, a PC, or any other networked computer configured to transmit search criteria and receive search results. Tablet 600 has touch screen 610, which may be a touch display with an integrated touch sensor or a display monitor used in conjunction with a pointing device such as a mouse. Each of users 110 may have a tablet 600.

Note taking system 100 may generate, for display on touch screen 610, a concept map showing concepts, such as concepts 620, 630, 640, 650, and 660. Edges between concepts may indicate correlations between concepts. For example because a right triangle has a hypotenuse, triangle types 660 is connected to triangle sides 640. Note taking system 100 may render the concept map as hypertext markup language (HTML) and transmit the HTML to a web browser of a student.

Once loaded in the web browser, the concept map may be interactive, including navigation within the concept map and navigation by opening a note in note tool 150 or a learning object in activity tool 160. For example, triangle types 660 indicates that there are thirteen notes associated with that concept. A user may click on the text of “13 notes” to view a list of the thirteen associated notes. The list of associated notes may be search results 430 of tablet 400 on FIG. 4. The list of associated notes may be interactive, such that the user may click on a note in the list to open that note in note tool 150.

Triangle types 660 also indicates that there are two learning objects associated with that concept. The user may click on the text of “2 objects” to view a list of the two associated learning objects. The user may then click on a learning object in the list to open the learning object in an appropriate tool.

Learning objectives are groups of concepts that students are expected to learn. A learning objective may be an academic standard, such as a Common Core standard. Triangle types 660 indicates that there is one learning objective associated with that concept. The user may click on the text of “1 objective” to open the learning objective in an appropriate tool.

Students or an author of a learning object may use tablet 600. Tools associated with note taking system 100 may have navigational links that cause display of a concept map. For example, note tool 150 may allow navigation to a concept map that has a concept indicated by the metadata of a note currently viewed in note tool 150.

The concept map shown is small and acyclic. However, a concept map may have cycles. Because the concepts of an academic course are likely to be interrelated and cohesive, a concept map may include most or all concepts of the course. A concept map may have pan and zoom functionality for interactive browsing of a large concept map.

### Hardware Overview

According to one embodiment, the techniques described herein are implemented by one or more computing devices. The computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the techniques. The computing devices may be desktop computer systems, portable computer systems, handheld devices, networking devices or any other device that incorporates hard-wired and/or program logic to implement the techniques.

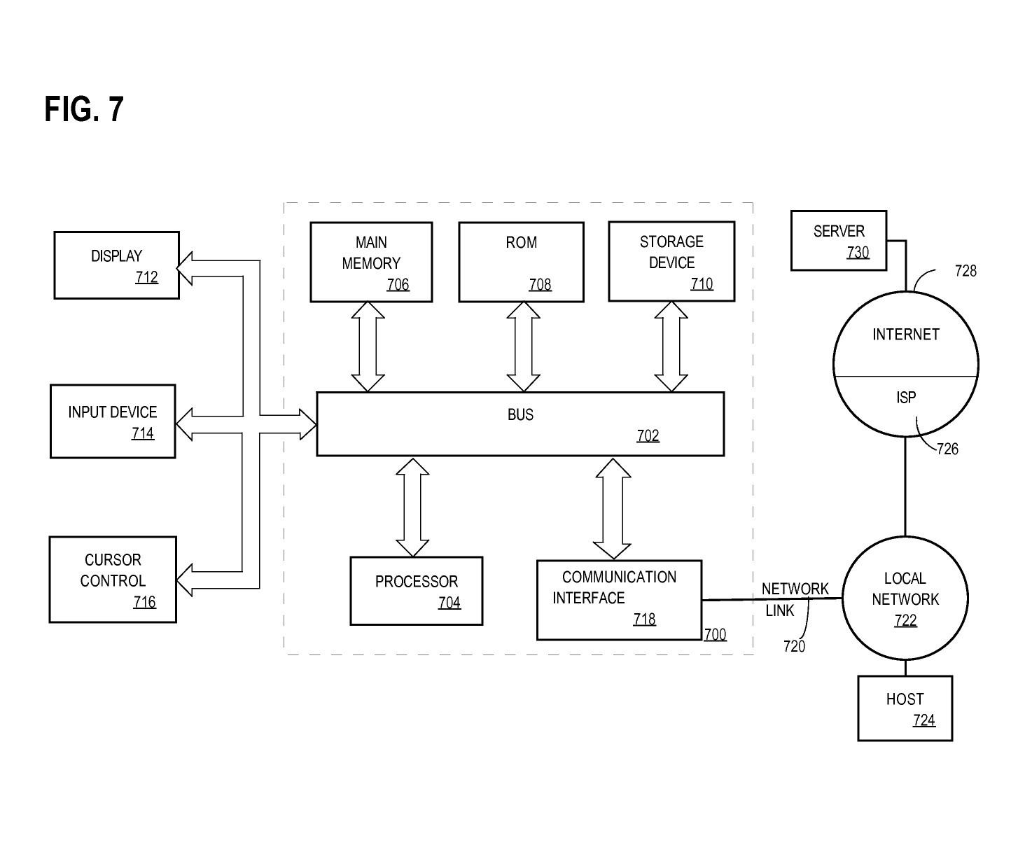

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method performed by an online teaching system that is implemented by one or more computing devices, the method comprising:
a note analyzer automatically determining that a plurality of notes taken by a plurality of users using a note tool were taken in conjunction with the plurality of users participating in a particular activity, related to a particular learning object, using an activity tool that enables participation in the particular activity;
the note analyzer generating metadata for each note of the plurality of notes based, at least in part, on at least one of:
a semantic analysis of content of the note;
content of the particular learning object;
note creator performance information that indicates how the user that created the note performed on one or more tasks;
note reader performance information that indicates how users that read the note performed on one or more tasks; or
professional performance information of the user that created the note;
the note analyzer storing data that associates each note of the plurality of notes with the metadata generated for the note; and
performing a further action on the plurality of notes based, at least in part, on the metadata generated for each note.

2. The method of claim 1 wherein the metadata for at least one note of the plurality of notes is generated based on a semantic analysis of content of the note.

3. The method of claim 1 wherein the metadata for at least one note of the plurality of notes is generated based on note creator performance information.

4. The method of claim 1 wherein the metadata for at least one note of the plurality of notes is generated based on note reader performance information.

5. The method of claim 1 wherein:
generating metadata for each note of the plurality of notes includes assigning each note of the plurality of notes to one or more categories; and
the further action is performed based, at least in part, on the categories to which each of the plurality of notes have been assigned.

6. The method of claim 5 further comprising providing a tool that performs at least one of: enables users to assign categories to notes within the plurality of notes, or displays an interactive concept map.

7. The method of claim 1 wherein a particular note of the plurality of notes has a particular privacy setting, and the online teaching system restricts which users of the plurality of users have access to the particular note based on the privacy setting.

8. The method of claim 1 further comprising, in response to receiving search criteria from a particular user, the online teaching system sending to the particular user a list of notes that match the search criteria, wherein at least one note in the list of notes is a note, from the plurality of notes, that was created by a user other than said particular user.

9. The method of claim 8 further comprising the online teaching system determining which notes match the search criteria based, at least in part, on the metadata associated with each of the notes.

10. The method of claim 8 further comprising the online teaching system sorting the list based on a popularity score of each note of the list, wherein the popularity score is based on at least one of:
an amount of views of the note by users, or
quality ratings of the note by users.

11. The method of claim 1 wherein performing a further action includes generating a revision of the particular learning object based on at least one note of the plurality of notes.

12. The method of claim 11 wherein generating the revision comprises the online teaching system:
selecting a particular note based on a popularity score associated with the particular note; and
generating the revision to the particular learning object based on the particular note.

13. The method of claim 11 wherein generating the revision comprises the online teaching system:
selecting a particular note based on an academic performance information of a user that created the particular note; and
generating the revision to the particular learning object based on the particular note.

14. The method of claim 11 wherein generating the revision comprises the online teaching system:
selecting a particular note based on an academic performance information of one or more users that viewed the particular note; and
generating the revision to the particular learning object based on the particular note.

15. The method of claim 11 wherein generating the revision comprises the online teaching system:
selecting the particular learning object based on an amount of notes associated with the particular learning object; and
generating the revision to the particular learning object based on at least one of the associated notes.

16. The method of claim 11 wherein a particular note comprises a hyperlink to an external resource, wherein generating the revision comprises the online teaching system selecting the particular note based on an aggregate amount of time users spent viewing the external resource.

17. The method of claim 1 further comprising, based on semantic analysis of content of multiple notes associated with a learning object, the online teaching system generating a replacement note that combines portions of the multiple notes, wherein the semantic analysis identifies redundancy between the multiple notes.

18. The method of claim 1 wherein a note comprises an indicator of a location within a learning object associated with the note, wherein the learning object comprises one of: a video, an audio, a slide show, or an electronic book.

19. One or more non-transitory computer-readable media comprising instructions that when executed by a plurality of processors cause:
automatically determining that a plurality of notes taken by a plurality of users using a note tool were taken in conjunction with the plurality of users participating in a particular activity, related to a particular learning object, using an activity tool that enables participation in the particular activity;
generating metadata for each note of the plurality of notes based, at least in part, on at least one of:
a semantic analysis of content of the note;
content of the particular learning object;
note creator performance information that indicates how the user that created the note performed on one or more tasks;
note reader performance information that indicates how users that read the note performed on one or more tasks; or
professional performance information of the user that created the note;
storing data that associates each note of the plurality of notes with the metadata generated for the note; and
performing a further action on the plurality of notes based, at least in part, on the metadata generated for each note.

20. An online teaching system comprising:
a plurality of durable storage media configured to store notes and associated metadata generated for each of the notes;
a plurality of processors connected to the plurality of durable storage media;
instructions that, when executed by the plurality of processors, cause:
automatically determining that a plurality of notes taken by a plurality of users using a note tool were taken in conjunction with the plurality of users participating in a particular activity, related to a particular learning object, using an activity tool that enables participation in the particular activity;
generating metadata for each note of the plurality of notes based, at least in part, on at least one of:
a semantic analysis of content of the note;
content of the particular learning object;
note creator performance information that indicates how the user that created the note performed on one or more tasks;
note reader performance information that indicates how users that read the note performed on one or more tasks; or
professional performance information of the user that created the note;
storing, on the plurality of durable storage media, data that associates each note of the plurality of notes with the metadata generated for the note; and
performing a further action on the plurality of notes based, at least in part, on the metadata generated for each note.
